(19) United States
(12) Patent Application Publication
(10) Pub. No.: US 2012/0315362 A1
(43) Pub. Date: Dec. 13, 2012

(54) BIODEGRADABLE, EDIBLE, WEATHER RESISTANT CONTAINER FOR LIVESTOCK FEED SUPPLEMENT BLOCK

(75) Inventors: Ross Dean Dale, Pella, IA (US); Paul Gene Summer, Oskaloosa, IA (US); Dwayne Lyndon Jantz, Bloomfield, IA (US)

(73) Assignee: Golden Nutrition, LLC., Oskaloosa, IA (US)

(21) Appl. No.: 13/293,297

(22) Filed: Nov. 10, 2011

Related U.S. Application Data
(60) Provisional application No. 61/412,222, filed on Nov. 10, 2010.

(51) Int. Cl. B65D 65/38; A23D 9/00; A23P 1/08

(52) U.S. Cl. 426/138; 426/307; 426/607

(57) ABSTRACT

A method for the production of a bio-degradable, weather resistant container for solidified livestock feed supplement blocks is disclosed. The method includes forming a wax container around the supplement block with liquid wax that has a high melting point. A biodegradable, edible, weather resistant container for a solidified feed supplement block is also disclosed. The container comprises a wax container formed around the supplement block. The wax container may be a solidified liquid wax having a high melting point. A feed supplement for an animal is also disclosed which comprises a solidified feed supplement block packaged within a biodegradable, edible, weather resistant container.

### CROSS-REFERENCE TO RELATED APPLICATIONS

This application claims the benefit of U.S. Provisional Application 61/412,222 entitled “Biodegradable, Edible, Weather Resistant Container for Livestock Feed Supplement Block” filed on Nov. 10, 2010, the entire contents of which is hereby incorporated by reference herein in its entirety.

### FIELD

The invention relates primarily to the packaging of solidified livestock feed supplement blocks and more particularly to the formation of an organic, biodegradable, edible, weather resistant package for solidified livestock feed supplement blocks.

### BACKGROUND

It is common practice to supplement livestock diets with purchased nutrients such as trace minerals, vitamins, protein and carbohydrates as required by the livestock. Supplements for livestock can be purchased in many forms such as loose mineral, pelleted feeds, salt blocks, mineral blocks, protein blocks and molasses blocks. Supplements formed into solidified blocks range in size from 30 pounds up to 250 pounds typically. Solidified livestock feed supplement blocks are advantageous because they permit free choice feeding to the animals, thereby reducing labor costs by not requiring daily supplement feeding. The animals lick a certain amount of feedstuff off of the supplement block daily and intake is limited by the hardness of the block.

Supplement blocks are commonly packaged in protective containers such as metal drums or plastic drums that have open tops, allowing access to the feedstuff. The containers are necessary and allow the supplement blocks to be placed onto the ground and outdoors. They keep the supplement block contained and prevent it from ‘falling apart’ as well as protect it from moisture due to rain or wet ground as well as keep the feedstuff clean of mud or dirt. Metal or plastic containers are very effective; however, once the supplement block is consumed they must be recycled or disposed. These actions require more labor and cost. More recently, some supplement block manufacturers have offered packaging such as cardboard or combinations of paper fiber, straw and wood chips composited into a mold. These containers eliminate the need to be recycled or disposed when empty; however, they are not as moisture resistant compared with metal or plastic and do not withstand environmental conditions as well, exposing the feedstuff to potential spoilage.

Therefore, there is a need for a solidified livestock feed supplement block container that is both bio-degradable and weather resistant. Further, there is need for a container that is edible and economical to manufacture. Further, there is a need for a container that can be formed easily to fit any size or shape of solidified livestock feed supplement block.

### SUMMARY

Accordingly, a method for the production of a bio-degradable, weather resistant container for solidified livestock feed supplement blocks is provided. The method includes forming a wax container around the supplement block with liquid wax that has a high melting point.

A biodegradable, edible, weather resistant container for a solidified feed supplement block is also provided. The container comprises a wax container formed around the supplement block. The wax container may be a solidified liquid wax having a high melting point.

A feed supplement for an animal is also provided which comprises a solidified feed supplement block packaged within a biodegradable, edible, weather resistant container.

### BRIEF DESCRIPTION OF THE DRAWINGS

Various examples of embodiments of the product and methods according to the present disclosure will be described in detail, with reference to the following figures, wherein:

FIG. 1 is a perspective view of one or more examples of a bio-degradable, edible, weather resistant container package and livestock feed supplement block, showing a feed supplement block covered with the container package.

FIG. 2 is a perspective view of the one or more examples of a bio-degradable, edible, weather resistant container package and livestock feed supplement block shown in FIG. 1, showing one example of a feed supplement block partially covered with the container package, the container package being illustrated in hash-lines.

FIG. 3 is a cross-sectional view of the one or more examples of a bio-degradable, edible, weather resistant container taken from line 3-3 of FIG. 1.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

One or more examples of bio-degradable, edible, weather resistant and economical container package for solidified livestock feed supplement blocks and method of manufacturing are disclosed.

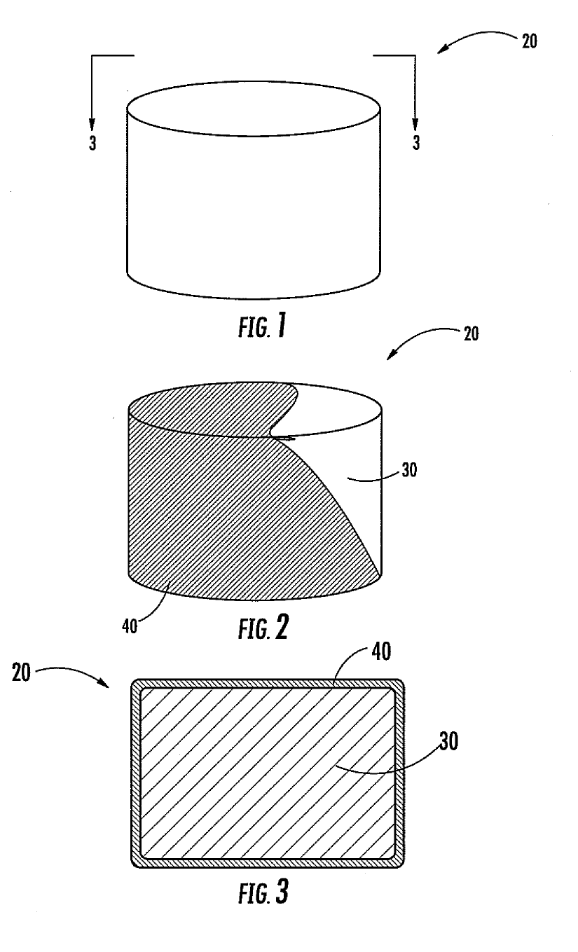

A combined solidified livestock feed supplement block and container package 20 are shown in FIGS. 1-3. A wax container 40 formed according to the present invention can be used for any solidified livestock feed supplement block 30 including any practical shape or size. The shape of the feed supplement block 30 used by the present invention may be a cylinder, square, rectangle or pyramid. In one or more examples of embodiments, the block 30 is formed by pressing at high pressure, semi-dry feed ingredients, along with reactants known to the art, into a cylinder shaped mold to from a cylinder shaped feed supplement block 30. In one example, the present invention forms a container 40 for supplement blocks ranging in size from about 5 pounds to about 500 pounds, more preferably from about 30 pounds to about 300 pounds, and even more preferably from about 150 pounds to about 250 pounds.

In one or more examples of embodiments, a solidified livestock feed supplement block 30 is formed by any of a number of methods such as those described by but limited to U.S. Pat. No. 4,027,043, U.S. Pat. No. 4,160,041, U.S. Pat. No. 4,171,385, U.S. Pat. No. 4,234,608, U.S. Pat. No. 4,431,675, U.S. Pat. No. 4,994,282, U.S. Pat. No. 5,068,114, U.S. Pat. No. 5,073,388, and U.S. Pat. No. 6,168,803 (The contents of each of these references is hereby incorporated by reference). The solidified feed supplement 30 may be manufactured by pouring combinations of liquid ingredients into a mold for reaction and solidification or it may be comprised of primarily dry ingredients which are compressed under high pressure to form a solidified block 30. In any case, the solidified supplement block(s) 30 may require a curing step and cooling step while chemical reactions reach their endpoints which results in the hard block 30.

Once the block(s) 30 are cooled to ambient conditions, the present container 40 is formed onto the block 30 to provide a package for delivery and protection of the supplement block 30, as well as providing an adaptable process to accommodate any block size or multiple block sizes.

The container 40 may be formed onto the feed supplement block 30 by immersing the feed supplement block 30 into a pool of liquid wax and subsequently removing the block 30 from the pool. The block 30 may be held by any suitable means known in the art. Likewise, the pool of liquid wax may be provided in any suitable container 40 for retaining liquid wax, and preferably retaining wax at a pre-defined temperature and having a depth suitable for the desired depth of immersion of the block 30. The block 30 may be immersed into the pool by automated or manual means known in the art. One block may be formed as described or a plurality of blocks may be made simultaneously. The supplement block 30 is immersed for a time period equal to between 5 seconds and 10 minutes, more preferably between 5 seconds and 2 minutes, and even more preferably between 5 seconds and 30 seconds. Upon removal from the liquid wax pool, the container 40 quickly forms as a continuous layer on the outside of the feed block 30 (see FIG. 3).

The block 30 may be fully immersed to form an essentially airtight container 40 or partially immersed, such as but not limited to, being immersed only as deep as the blocks' height to form a container 40 which covers the bottom and sides of the block 30, allowing a portion of the block 30 to be exposed.

In the process of the present invention, any source of material suitable to form a wax type substance having the various properties described herein is used for the liquid container material. The liquid material may be a wax chosen from hydrogenated vegetable oils and with a melting point at or above 80° F. More preferably, any source of wax with a melting point at or above 110° F., and even more preferably any source of wax with a melting point at or above 130° F. may be used for the material forming the container 40 described herein. Waxes can be chosen from any hydrogenated vegetable oil such as coconut oil, corn oil, cottonseed oil, olive oil, palm oil, peanut oil, rapeseed oil, safflower oil, sesame oil, soybean oil or sunflower oil or combinations of the foregoing. The wax used is preferably chosen from hydrogenated soybean oil or corn oil or any combinations thereof. In one embodiment, crude, unrefined oils, such as soybean or corn oils, are hydrogenated and used for the wax container 40. For example, crude corn oil recovered from ethanol byproduct stillage in a corn to ethanol dry mill plant works well when hydrogenated and utilized as a wax container 40 in the present invention.

Waxes used in one or more examples of embodiments are preferably edible by livestock. Ideal waxes are those produced from hydrogenation of vegetable oils, such as, but not limited to, coconut oil, corn oil, cottonseed oil, olive oil, palm oil, peanut oil, rapeseed oil, safflower oil, sesame oil, soybean oil or sunflower oil and combinations of the foregoing.

The thickness of the wax container 40 can be varied for a variety of purposes, such as but not limited to, to meet product requirements or market preferences. In one or more examples of embodiments, the supplement block 30 is immersed into the liquid wax multiple times while allowing sufficient cooling between immersions to solidify the wax container 40. Each immersion adds an additional layer to the container 40 and results in a thicker container 40. In another embodiment, several liquid waxes of differing melting points are employed as multiple layers of the container 40. For example, the first immersion of the supplement block 30 may be into a liquid wax with a melting point greater than 160° F., the second immersion into wax with a melting point greater than 150° F., the third immersion into wax with a melting point greater than 140° F., and so on. The container 40 thickness is preferably from about 0.06 inches to about 1.25 inches, or more preferably from about 0.15 inches to about 1.00 inches, or even more preferably from about 0.25 inches to about 0.50 inches. While specific examples are provided, variations thereon would not depart from the overall scope of the present invention.

The thickness of the container 40 can be varied from bottom to top, offering greater protection for the base of the supplement block 30. In one or more examples of embodiments, the supplement block 30 may be immersed into liquid wax sufficiently to form a container 40 to cover the full height of the block 30. After the container 40 cools and solidifies, a second immersion is made sufficient to form an additional container layer to cover one half the height of the block 30. After the container 40 cools and solidifies, a third immersion is made sufficient to form an additional container layer to cover a portion, such as one fourth the height, of the block 30. Variations in height or portions covered, up to an including the entire block 30, would not depart from the overall scope of the invention. Alternatively, each container layer can be formed with waxes of differing melting points. For example, the first layer can be formed with wax having a melting point of 160° F., the second layer with a wax having a melting point greater than 150° F., a third layer with a wax having a melting point greater than 140° F., and so on. While specific examples are provided, variations on the foregoing would not depart from the overall scope of the invention.

The hardness of the wax container 40 can be altered by adding hardening agents to the liquid wax. In one embodiment, stearic acid may be added to liquid wax to facilitate the formation and durability of the wax container 40. For example, stearic acid may be added to equal from about 0.1 wt. % to about 10 wt % of the liquid wax, more preferably from about 0.5 wt % to about 8 wt % of the liquid wax, and even more preferably from about 1 wt % to about 5 wt of the liquid wax.

The color of the wax container 40 may also be changed to meet product requirements, differentiate product formulas, or to meet certain market demands. The color of the wax container 40 is altered by the addition of wax soluble coloring agents. In one or more examples of embodiments, one or more edible dyes are added to the liquid wax material.

The container formed according to the present invention is stable in hot environments. In particular, the container has a high melting point, and more specifically, a melting point which is sufficient to avoid melting when exposed to natural environmental conditions. For example, when used for grazing livestock in summer season, ambient temperatures can reach as high as 100 F or slightly more in extreme conditions. The container in one or more examples of embodiments has a melting point of at least 81 degrees F. and as high as 200 degrees F., depending upon the wax employed for the desired conditions. When produced for sale, storage and use in hotter environments, a higher melting point wax may be used and indefinite stability is conferred to the container. Therefore, the container is non-degradable by heat alone, but rather it is bio-degradable.

While livestock are specifically described in reference to the examples of embodiments discussed herein, the present invention can be used for any solidified block 30 intended for use to supplement wildlife such as, but not limited to, deer, moose or caribou. Further, the present invention can be used for any solidified block 30 intended for use to supplement pets such as, but not limited to, dogs, cats, rabbits or horses.

The product of the present invention is an improved container package for solidified livestock feed supplement blocks 30. While in the examples of embodiments described herein, the container is described to be formed by or including wax, other materials having the same or similar properties may be acceptable for use with the present invention.

A bio-degradable container for solidified livestock feed supplement blocks and a method for producing a biodegradable, weather resistant and economical container for solidified livestock feed supplement blocks are provided. The container has various advantages. It is an edible container made with edible vegetable oils that provides a combination of protection for a supplement block along with added nutrients for livestock when consumed in conjunction with the supplement block. Advantageously, the bio-degradable container is weather resistant and moisture proof. A wax formed container that is completely weather resistant and can even be formed to envelop 100 percent of the block surface for weather resistance until the block are put into use. Moreover, the container that is easy and economical to manufacture. More specifically, the container is lower in cost compared with current state of the art containers. Additionally, the container is a flexible sized container that can conform in shape or size to mold onto any supplement block, thereby eliminating the need to stock several sized containers for different products. Another advantage of the present invention is the container will form to accommodate any size or shape supplement block. Further, the bio-degradable container eliminates the need to recycle or dispose used containers. These and other objects and advantages will be apparent from the description, claims and drawings herein.

Various examples of embodiments of the methods according to the present invention include, generally, forming a container comprised primarily of wax onto a feed supplement block. Methods according to the present invention are both feasible and advantageous because they form a bio-degradable, weather resistant and economical container for supplement blocks compared with the current state of the art. By employing such a container forming method, the packaging of supplement feed blocks becomes immediately adaptable to any shape or size utilizing the same raw material source, thereby eliminating the need to stock several container sizes for different product sizes. Further, weather resistant wax containers, as illustrated in one or more examples of embodiments, are bio-degradable and edible when edible waxes are employed. The container thickness can also be easily altered to meet product requirements by simply altering the wax formulation and temperature of the wax during the container forming process.

The container is economically produced compared with state of the art. For example, 200 pound supplement block with approximate dimensions of 24 inches height X 22 inches diameter may require approximately 2 pounds of wax to form a container with a thickness of 0.20 inches that covers the entire surface area of the block. Wax costs are currently equal to between about $0.75 per pound to about $1.75 per pound. Accordingly, container costs for a 200 pound supplement block with the present invention would cost from about $1.50 to about $3.50. By comparison, current state of art uses plastic, steel or cardboard containers and range in price from about $5.00 to about $10.00 per container for a 200 pound block.

Having generally described this invention, a further understanding can be obtained by reference to an example provided herein for purpose of illustration only and not intended to limit the scope of the invention unless otherwise specified.

### EXAMPLE

A solidified livestock feed supplement block weighing 200 pounds was formed using the formula in Table 1. The supplement block was allowed to cool for at least 24 hours before forming a wax container for final packaging. A steel container containing soy-wax with a melting point of 120 degrees F. was heated with a propane burner to melt the wax and maintain it at just about its' melting point temperature. The supplement block was mechanically immersed into the liquid wax for 10 seconds, removed and allowed to cool. A hard and durable wax container was formed onto the supplement block with a thickness equal to about 0.25 inches.

The supplement block with the present invention container was placed into a field with 14 cows to observe the acceptance of the block by cattle as well as its' durability in field conditions. It was observed that the cows readily consumed the block at the desired rate of consumption and that the wax container remained intact over the course of two weeks while the block was consumed. Interesting, the cows also consumed the container as they were consuming the block. However, they didn't preferentially consume the container to leave an exposed supplement bock but rather they consumed the supplement block and the container at nearly the same rate so that the block and its' container disappeared nearly simultaneously.

The amount of liquid wax used to form the container package for a 200 pound block in the present example was equal to 2 pounds. Thus, the material cost of the container is roughly $2.50, compared with $5-$10 per container of equal size for plastic or steel drums, respectively. Cardboard, paper fiber, or composite drums made with wood, straw and other materials cost roughly 25% more compared with plastic drums. They are biodegradable but don't offer equal weather resistance compared with plastic or steel. The present invention wax container is superior to current containers due to lower cost of production and equal weather resistance compared with plastic or steel.

TABLE 1
Solidified Livestock Feed Supplement Block

| Item | Weight % |
|---|---|
| Dried Distillers Grains | 50 |
| Cane Molasses | 25 |
| Whey | 11 |
| Phosphoric Acid | 2 |
| Processed Vegetable Oil | 2 |
| Calcium Oxide | 8 |
| Vitamin and Trace Mineral Mixture | 2 |

Presently preferred embodiments of the invention and many of its improvements have been described with a degree of particularity. The previous description is of preferred examples for implementing the invention, and the scope of the invention should not necessarily be limited by this description. Although various representative embodiments of this invention have been described above with a certain degree of particularity, those skilled in the art could make numerous alterations to the disclosed embodiments without departing from the spirit or scope of the inventive subject matter set forth in the specification and claims. All directional references (e.g., upper, lower, upward, downward, left, right, leftward, rightward, top, bottom, above, below, vertical, horizontal, angled, and so forth) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly. As such, joinder references do not necessarily infer that two elements are directly connected and in fixed relation to each other. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It is also important to note that the construction and arrangement of the feedstock and/or container as described in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements described as integrally formed may be constructed of multiple parts or elements show as multiple parts may be integrally formed, the interfaces may be reversed or otherwise varied, the length or width of the structures and/or members or other elements of the device or composition may be varied, the nature or number of adjustment positions provided between the elements may be varied. The order or sequence of any process or method steps may be varied or re-sequenced according to alternative embodiments. Other substitutions, modifications, changes and omissions may be made in the design, operating conditions and arrangement of the various exemplary embodiments without departing from the spirit or scope of the present inventions.

What is claimed is:

1. A method for the production of a bio-degradable, weather resistant container for solidified feed supplement blocks comprising forming a wax container around a feed supplement block with liquid wax that has a high melting point.

2. The method of claim 1 wherein the feed supplement block is pre-formed and cooled to ambient condition and is comprised of any combination of liquid or dry feeds or combinations thereof to form a solidified supplement block.

3. The method of claim 1 wherein the wax has a melting point from 81 degrees F. to 200 degrees F.

4. The method of claim 1 wherein the wax container ranges in thickness from about 0.06 inches to 1.25 inches.

5. The method of claim 1 wherein the wax container varies in thickness from top to bottom.

6. The method of claim 1 wherein a container thickness is varied by controlling the temperature of the liquid wax.

7. The method of claim 1 wherein the supplement block ranges in size from about 10 pounds to about 500 pounds.

8. The method of claim 1 wherein the liquid wax is heated to a temperature from about 81 degrees F. to about 200 degrees F.

9. The method of claim 1 wherein liquid wax is comprised of hydrogenated vegetable oils selected from coconut oil, corn oil, cottonseed oil, olive oil, palm oil, peanut oil, rapeseed oil, safflower oil, sesame oil, soybean oil, sunflower oil, and combinations of one or more of the foregoing.

10. The method of claim 1 wherein the liquid wax contains a coloring additive.

11. The method of claim 1 wherein the liquid wax contains a hardening agent.

12. A biodegradable, edible, weather resistant container for a solidified feed supplement block comprising a wax container formed around the supplement block said wax container comprising a solidified liquid wax having a high melting point.

13. The container of claim 12 wherein the feed supplement block comprises a combination of liquid or dry feeds or combinations thereof to form a solidified supplement block.

14. The container of claim 12 wherein the liquid wax has a melting point from 81 degrees F. to 200 degrees F.

15. The container of claim 12 wherein the wax container ranges in thickness from about 0.06 inches to 1.25 inches.

16. The container of claim 12 wherein the wax container varies in thickness from top to bottom.

17. The container of claim 12 wherein the supplement block ranges in size from about 10 pounds to about 500 pounds.

18. The composition of claim 12 wherein liquid wax is comprised of hydrogenated vegetable oils selected from the group consisting of coconut oil, corn oil, cottonseed oil, olive oil, palm oil, peanut oil, rapeseed oil, safflower oil, sesame oil, soybean oil, and sunflower oil and combinations of the foregoing.

19. The container of claim 12 wherein the liquid wax contains a coloring additive.

20. The container of claim 12 wherein the liquid wax contains a hardening agent.

21. A feed supplement for an animal comprising a solidified feed supplement block packaged within a biodegradable, edible, weather resistant container.

22. The feed supplement of claim 21 wherein the feed supplement block is packaged within a biodegradable, edible, weather resistant container comprising a wax container formed around at least a portion of the supplement block and comprising a solidified liquid wax that has a high melting point.
